(19) United States
(12) Patent Application Publication
(10) Pub. No.: US 2025/0103386 A1
(43) Pub. Date: Mar. 27, 2025

(54) PROCESS SMART DEPENDENCIES DETECTION

(71) Applicant: International Business Machines Corporation, Armonk, NY (US)

(72) Inventors: Gabriele Ranco, Udine (IT); CORNELIU NICOLAE BARBULESCU, Otopeni (RO)

(21) Appl. No.: 18/508,407

(22) Filed: Nov. 14, 2023

(30) Foreign Application Priority Data
Sep. 25, 2023 (GB) 2314630.1

(51) Int. Cl. G06F 9/48; G06F 9/38

(52) U.S. Cl. CPC G06F 9/4881; G06F 9/3838

(57) ABSTRACT

A computer-implemented method for controlling a plurality of IT processes comprises measuring periodically start-times and related end-times of each of the plurality of IT processes during a first time interval, determining, for each of the IT processes, regularized binary time-series data based on the measured start-times and the related end-times, during a second time interval, building a plurality of vectors, wherein each component of each of the vectors of the plurality represents data of a respective one of the time-series data of the plurality of IT processes during a given second time interval, training of a machine-learning system to build a machine-learning model using the plurality of vectors as training data, thereby determining weights for edges between nodes of the machine-learning system, and using the determined weights of the edges between the nodes as indicators for dependencies between the IT processes.

### BACKGROUND

Invention aspects relate generally to controlling IT processes, and more specifically, to a computer-implemented method for controlling a plurality of IT processes. The invention relates further to a control system for controlling a plurality of IT processes, and a related computer program product.

Today's IT (information technology) management continues to struggle with the complexity of deployed hardware, middleware, networks, application software and many other elements in a componentized, service-oriented and hybrid IT universe comprising on-premises and cloud computing resources. In order to keep control across this complex computing environment, IT management has to execute thousands of processes or IT jobs in context of, e.g., data migration or integration, business process execution, IT jobs for server migration and administration and/or DevSecOps jobs.

In reality, there is no single person who can understand the entire enterprise IT landscape of these components and no single governance repository tool that comprehensively, consistently, and accurately stores all dependencies of the above-mentioned components at all times. This is in particular true in a world of dynamic VMs (virtual machines), dynamic container and cloud deployments, many “as-a-service” elements, software-defined “anything” and proliferation of edge devices, e.g., IoT (Internet-of-Things) devices.

The lack of this common understanding makes it difficult to manage and control dependencies between these components when planning, designing, building, and executing them. Therefore, up to now, it is merely impossible to have an automatic solution that may allow specialists and decision-makers to easily understand and visualize all dependencies of their IT jobs. Also, artificial intelligence based approaches have not overcome the existing difficulties.

Hence, companies that need to modernize their IT infrastructure may need specific help in such process. However, the presence of legacy systems and the short time available to find optimization points in the IT landscape makes it complicated for consultants to rapidly understand the existing structure of the IT landscape, and hence a solution to be developed. For this reason, a unique system that visualizes, in a single view, all information regarding the IT processes may be of high value in order to control and manage all IT processes, allowing an efficient scheduling of processes and their execution.

So far, existing solutions require a usage of an ad-hoc approach for developing optimization solutions and an interaction with the scheduler of the IT jobs. This may also create issues with security requirements when high-level access credentials need to be used in order to access relevant data to analyze dependencies between the IT processes.

In this context, a couple of approaches have already been described: Document U.S. Pat. No. 9,223,628 B2 describes a task scheduling based on dependencies and available resources. Thereby, a set of tasks as being designated for execution is identified. The set of tasks includes at least a first task and a second task. A related system accesses task dependency data that correspond to the second task and indicates that the first task is to be executed prior to the second task. Additionally, document U.S. Pat. No. 10,713,088 B2 describes an event-driven scheduling using directed acyclic graphs. Thereby, a directed acyclic graph is generated that comprises a plurality of nodes and a plurality of edges. The nodes represent jobs, and the edges represent dependency relationships between individual jobs and then, based on one or more events, a job scheduler determines that one of the nodes represents a runnable job satisfying the dependency relationship.

Although such partial solutions may be helpful for IT management requirements of limited complexity, real-life IT management and control tasks of existing large enterprise IT landscapes cannot be addressed for the exemplary IT migration tasks at hand, as described above.

### SUMMARY

According to one aspect of the present invention, a computer-implemented method for controlling a plurality of IT processes may be provided. The method may comprise measuring periodically start-times and related end-times of each of the plurality of IT processes during a first time interval, determining, for each of the IT processes, regularized binary time-series data based on the measured start-times and the related end-times, during a second time interval, and building a plurality of vectors, wherein each component of each of the vectors of the plurality represents data of a respective one of the time-series data of the plurality of IT processes during a given second time interval.

Furthermore, the method may comprise training of a machine-learning system to build a machine-learning model using the plurality of vectors as training data, thereby determining weights for edges between nodes of the machine-learning system, and using the determined weights of the edges between the nodes as indicators for dependencies between IT processes.

According to another aspect of the present invention, a control system for controlling a plurality of IT processes may be provided. The system may comprise one or more processors and a memory operatively coupled to the one or more processors, wherein the memory stores program code portions which, when executed by the one or more processors, enable the one or more processors to measure periodically start-times and related end-times of each of the plurality of IT processes, to determine, for each of the IT processes, regularized binary time-series data based on the measured start-times and the related end-times, and to build a plurality of vectors, wherein each component of each of the vectors of the plurality represents data of a respective one of the time-series data of the plurality of IT processes.

Additionally, one or more processors may also be enabled to train a machine-learning system to build a machine-learning model using the plurality of vectors as training data, thereby determining weights for edges between nodes of the machine-learning system, and to use the determined weights of the edges between the nodes as indicators for dependencies between the IT processes.

Furthermore, embodiments may take the form of a related computer program product, accessible from a computer-usable or computer-readable medium providing program code for use by or in connection with a computer or any instruction execution system by or in connection with a computer or any instruction execution system. For the purpose of this description, a computer-usable or computer-readable medium may be any apparatus that may contain means for storing, communicating, propagating, or transporting the program for use by or in connection, with the instruction execution system, apparatus, or device.

### BRIEF DESCRIPTION OF THE DRAWINGS

It should be noted that embodiments of the invention are described with reference to different subject-matters. In particular, some embodiments are described with reference to method type claims, whereas other embodiments are described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered to be disclosed within this document.

Preferred embodiments of the inventive concept will be described, by way of example only, and with reference to the following drawings to which the inventive concept—for which variations and at least partial substitutions exist—is not limited:

FIG. 1 shows a block diagram of an embodiment of the inventive computer-implemented method for controlling a plurality of IT processes;

FIG. 2 shows a block diagram of an embodiment of the inventive computer-implemented method for a specific application;

FIG. 3 shows a diagram of execution trees of IT processes;

FIG. 4 shows a diagram of an exemplary binary time series graph;

FIG. 5 shows an exemplary data flow from measured start and end-times of IT process to the machine-learning system to be trained;

FIG. 6 shows a block diagram of functional blocks for deploying the method for controlling a plurality of IT processes;

FIG. 7 shows an exemplary diagram dependency diagram of applying the technique of the minimal spanning tree;

FIG. 8 shows a block diagram of an embodiment of the inventive control system for controlling a plurality of IT processes; and

FIG. 9 shows an embodiment of a computing system comprising the system according to FIG. 8.

### DETAILED DESCRIPTION

Embodiments of the inventive concept can be described as follows:

According to one embodiment of the present invention, a computer-implemented method for controlling a plurality of IT processes may be provided. The method may comprise measuring periodically start-times and related end-times of each of the plurality of IT processes during a first time interval, determining, for each of the IT processes, regularized binary time-series data based on the measured start-times and the related end-times, during a second time interval, and building a plurality of vectors, wherein each component of each of the vectors of the plurality represents data of a respective one of the time-series data of the plurality of IT processes during a given second time interval.

Furthermore, the method may comprise training of a machine-learning system to build a machine-learning model using the plurality of vectors as training data, thereby determining weights for edges between nodes of the machine-learning system, and using the determined weights of the edges between the nodes as indicators for dependencies between IT processes.

According to another embodiment of the present invention, a control system for controlling a plurality of IT processes may be provided. The system may comprise one or more processors and a memory operatively coupled to the one or more processors, wherein the memory stores program code portions which, when executed by the one or more processors, enable the one or more processors to measure periodically start-times and related end-times of each of the plurality of IT processes, to determine, for each of the IT processes, regularized binary time-series data based on the measured start-times and the related end-times, and to build a plurality of vectors, wherein each component of each of the vectors of the plurality represents data of a respective one of the time-series data of the plurality of IT processes.

Additionally, one or more processors may also be enabled to train a machine-learning system to build a machine-learning model using the plurality of vectors as training data, thereby determining weights for edges between nodes of the machine-learning system, and to use the determined weights of the edges between the nodes as indicators for dependencies between the IT processes.

The proposed computer-implemented method for controlling a plurality of IT processes may offer—at least for some embodiments—multiple advantages, technical effects, contributions and/or improvements (which are not necessarily required for all embodiments):

As stated above, most existing solutions depend at least partially on heuristic and ad-hoc mechanisms to determine detailed dependencies between IT processes. As a simple example: process B shall not start before process A is finished.

Instead, the proposed solution may only use the information present in the log files of the underlying IT system. These data are not that sensitive if compared to the usage of more high-level descriptions. This may particularly be true because only the start and end-time of job executions may be used. In real scenarios, such log files could represent an overwhelming amount of data, and fast and informative results regarding process dependencies may be almost impossible to have, given the dimension of data and the number of processes.

Hence, the solution proposed here may rely on machine-learning principles—potentially also using GPUs—in an innovative way if compared with a standard usage of machine-learning (ML) systems. Instead of focusing on the accuracy of the prediction of the ML system, the aim is to identify weights values that may characterize a neural network model. The resulting network of nodes of the neural network system itself may be used as a result of the proposed concept. For this reason, one may leverage the mathematical evidence of the similarity within a specific type of network which may be regarded as a Boltzmann machine. As a reminder: A Boltzmann machine (also called Sherrington-Kirkpatrick model with external field or stochastic Ising-Lenz-Little model) is a stochastic spin-glass model with an external field, i.e., a Sherrington-Kirkpatrick model that is a stochastic Ising model. It is a statistical physics technique applied in the context of cognitive science. It may also be denoted as a Markov random field.

Boltzmann machines are theoretically intriguing because of the locality and Hebbian nature of their training algorithm (being trained by Hebb's rule), and because of their parallelism and the resemblance of their dynamics to simple physical processes. Boltzmann machines with unconstrained connectivity have not been proven useful for practical problems in machine-learning or inference yet, but if the connectivity is properly constrained, the learning may be made efficient enough to be useful for practical problems. These general principles may be used as part of the solution to address the above stated objective task. Surprisingly, these mechanics things from statistical physics may successfully and advantageously be applied to the dependency model between IT processes (i.e., IT jobs).

It may allow to be sure to find the most informative network representation of the data. In case even the time required to train the neural network would be too long, one may use appropriate approximation methods—i.e., “shortcuts”—that may allow to have an approximated but reasonable result, e.g., by using average data values instead of expected values. Finally, the application of the technique of minimal spanning tree may also be used to visualize the results.

The application of the above named concept may work here because the Boltzmann machine or the Inverse Ising Model, as it is called in physics, may identify the interactions between two neurons from a correlation between the binary time series created by their “spiking” activity. The end-time of the jobs can be easily transformed into such binary values by looking to the presence or absence of a significant delay in the final execution time of the jobs, i.e., IT processes. The delay may be easily computed by looking at the difference if compared to the median end-time value of each process. The usage of the steps (binary transforming, inference, visualization via graph theory technique, building execution schedule trees) may represent a novel and inventive method to monitor interactions—i.e., process dependencies—of complex IT systems and its usage may be justified by non-trivial mathematical property of neural network theory. Its usage may be of extreme value on an industrial scale.

In a nutshell, dependencies between IT processes in large and interdependent computing systems may be determined only by observing start- and end-times of jobs, i.e., IT processes and the knowledge of an average execution time of the related processes. Typically, such system's statistical data do not underlie high security requirements and no further metadata of the architecture of the IT system(s) may be required. Hence, not any highly skilled personnel knowing how to interpret highly complex process architectures may be required. Instead, a sophisticated but easy to use computer implemented method may be sufficient to determine IT process dependencies which would otherwise not be determinable because of its extreme high and dynamically changing number. Hence, the solution may boast a high level of ease-of-use characteristics and low skill requirements for system administrators.

In the following, additional embodiments of the inventive concept—applicable for the method as well as for the system—will be described.

According to an interesting embodiment, the method may also comprise visualizing the dependencies between the IT processes using the determined weights of the edges. This may be performed by creating a network graph comprising most or all IT processes (on the system(s) under observation), using a list of execution trees, e.g., using minimal spanning tree techniques. The strength of the dependencies between individual dependent IT processes may be visualized using color coding, thickness of lines or other characteristics of lines (e.g., dashed, solid, dotted, etc.) representing dependencies between high key processes which may be represented as nodes of a network.

According to an advantageous embodiment of the method, the measuring the start-times and the related end-times also may comprise determining representative execution times for each of the plurality of IT processes. These may be mean execution time values, expected execution time values or simple average execution time values for the respective IT processes. Also, a mixture of the named methods to determine the representative execution time may be used.

According to another preferred embodiment of the method, the regularized binary time-series data may be regularized in respect to a predetermined time unit, and the method may comprise using a binary time-series schema based on the representative execution times. It has been shown that time units of one day may be useful. During such a day—also other regular time intervals may be used—advantageously, representative execution times may be determined to form the basis for the binary time-series schema. Hence, a measurement of the execution time of an actual IT process may be compared with the representative execution time of the related process (which will be measured during the predetermined time unit, hence before the measurement of the actual execution time) would result in a logical “1” in the binary time series schema if the actually measured execution time would be longer than the representative execution time. In other cases (actual execution times value shorter or equal than the representative execution time value), a logical “0” would build the entry in the binary time-series schema.

According to a further developed embodiment, the method may also comprise determining the start-times—or better start-time values—and the related end-times—or better related end-time values—regularly in predefined time intervals. This may be performed on a daily basis, more often or even quasi-randomly. Depending on the available computing resources, the degree of correctness of the dependency analysis of between IT processes may adapt over time.

According to a further useful embodiment of the method, the representative execution times may be expected execution times (values) or average execution times (values) for each of the plurality of IT processes during the first time interval. In this context, the average values of the execution time—which may be easier to determine—may be used instead of expectation values for the execution times for each of the plurality of IT processes. Experimentally, it could be shown that such simplification would have only a very little influence on the accuracy of the resulting dependency model.

According to an interesting embodiment of the method, the machine-learning system may be a fully connected neural network with two layers of nodes. I.e., the network may comprise an input layer and a separate output layer. Thereby, the input layer is fully connected to the output layer, i.e., each node of the input layer may have a connection—i.e., an edge—and a related weight value to each node of the output layer.

According to an advantageous embodiment of the method, each node may represent one of the plurality of IT processes. This way, the Boltzmann machine and Ising model principles may be implemented in an elegant way. Hence, the weight values between the nodes of the input layer and the nodes of the output layer may advantageously directly represent the level of dependency between different nodes, i.e., between different IT processes.

According to a further developed embodiment, the method may also comprise allocating, in the sense of scheduling, the IT processes in respect to available IT resources. Thereby, an overall IT resource usage may be minimized. This is a result of, e.g., letting one IT process end before another, dependent IT process may be started.

According to a permissive embodiment of the method, the training of the machine-learning system may comprise using first vectors of the plurality of vectors as input for the machine-learning system; i.e., they may be redirected or loaded into the nodes of the input layer of the fully connected neural network. Additionally, second vectors of the plurality of vectors may be used as ground truth data, wherein the second vectors are pairwise directly subsequent to respective first vectors. Hence, the first vectors and the second vectors, respectively, may be used as input and output signals—i.e., the values of the respective components of the vectors—for the input layer of the fully connected neural network and as expected outcome of the ML system under training.

In the context of this description, the following technical conventions, terms and/or expressions may be used:

The term ‘IT process’ (information technology process) may denote any “job”—in mainframe computing terms—or any computer “process” (based on a program) that can be executed on a computing system and may be denoted as IT process in the context of this document. In a simplified form, an IT process may be an image of a program in execution. The different IT processes may be differentiated by an IT process specific process identification number. Thereby, not the PID of an operating system may be used because it may be changed every time an IT process may be started. Instead, the process identification number may be unique for the program—or parts thereof—underlying the specific IT process.

The term ‘start-time’ may denote a time value at which a specific IT process may be started, i.e., may begin to be executed.

The term ‘end-time’ may denote another later time value at which the specific IT process may be stopped or may end, i.e., may end to be executed.

The term ‘first time interval’ may denote a time period during which a representative execution time of an IT process may be determined. During that time period a specific IT process may be executed several times—ideally, as often as required to determine an expectation value for its execution time—in order to determine a duration which may be representative for a typical execution sign of that specific IT process.

The term ‘regularized binary time-series data’ may denote data which may only have a value of “0” or “1” in regular time intervals. A corresponding diagram is shown in the figures.

The term ‘second time interval’ may denote the time period during which the machine-learning system may be trained to build the machine-learning model. During the second time interval also the input training data and the expected output data for the training session can be prepared. This is in contrast to the term ‘first time interval’ during which the measured start-times and end-times of the IT processes/IT jobs are collected.

The term ‘vector’ may denote a set of values, where each value may be assigned to one component of the vector.

The term ‘machine-learning system’ may denote a system which may not function based on procedural programming but which may “learn” its characteristics—e.g., output signals as a response to input signals—from training data. This well-known concept may use a neural network comprising layers of nodes and connections between the nodes denoted as edges. The edges may carry weight values as a result of a training session of the neural network.

The term ‘machine-learning model’ may denote a set of parameter values potentially including also hyper-parameters for a given architecture of a neural network which may represent the status of the machine-learning system after the training has been finished. Thereby, the hyper-parameters may be characteristic for the kind of neural network and its configuration parameters. This may comprise the type of neural network used, the number of layers of nodes used, the activation function(s) of a node and potentially related parameter values, the number of nodes per layer, the characteristics of connections between nodes (fully connected versus partially connected), etc.

The term ‘training data’ may denote here input vectors being used as input data for a machine-learning system under training. Ground-truth data or labels of further but related vectors may be used as expected output values. The combination of the input vectors and the related output values form the pairs of vectors of training data for a supervised machine-learning process.

The term ‘representative execution time’ may denote here a typical expected or average execution time of a predefined IT process. The value of the representative execution time of a certain IT process may be determined based on a certain number of execution times of the predefined IT process E.g., one may observe a computing system and its IT processes and measure the execution time—i.e., the difference between the end-time value and the start-time value—and build an average value of all these measured execution time values.

Before describing the figures in detail, and more details of the theoretical background, as described above, the following concepts shall be explained:

Researchers have in detail studied similarities between the statistical mechanics of Ising models and the functional dynamics of neural networks. The Ising model is a theoretical model built for simulating the dynamics of ferromagnetic systems in physics. For the case discussed here, it is suggested that this analogy can be built between the presence of a delay in the execution of an IT job and the spike of a neuron: In a window of time, a single neuron i either does (σᵢ=+1) or does not (σᵢ=−1) generate an action potential or “spike”; if one computes the mean probability of spiking for each cell (or in our case job)(<σ_{i>}) and the correlations between pairs of cells (Cᵢⱼ=<σᵢσⱼ>−<σᵢ><σⱼ>) (or in the case here between the presence of a delay), then the maximum entropy model consistent with these data is exactly the Ising model:

$$P ( \{ {σ}_{i} \} ) = \frac{1}{Z} exp [ {\sum }_{i = 1}^{N} {h}_{i} {σ}_{i} + \frac{1}{2} {\sum }_{i \neq j}^{N} {J}_{ij} {σ}_{i} {σ}_{j} ] , \qquad ( 1 )$$

where {hᵢ} and the exchange couplings {Jᵢⱼ} have to be set to reproduce the measured values of {<σᵢ>} and {Cᵢⱼ}. One may recall that maximum entropy models are the least structured models consistent with known expectation values; thus, the Ising model is the minimal model imposed on us by measurements of the mean spike probabilities and pairwise correlations.

The central problem is to find the {hᵢ} and exchange interactions that reproduce the observed pairwise correlations. It is convenient to think of this problem more generally: When having a set of operators O [symbol] _{μ}({σᵢ}) on the state of the system, and one can consider a class of models:

$$P ( \{ {σ}_{i} \} \vert g ) = \frac{1}{Z ( g )} exp [ {\sum }_{μ = 1}^{K} {g}_{μ} {\hat{O}}_{μ} ( \{ {σ}_{i} \} ) ] , \qquad ( 2 )$$

Then, the problem is finding the coupling constants g that generate the correct expectation values, which is equivalent to solving the equations ∂lnZ(_{g})/∂g_{μ}=hO\hat{ }_{μ}({σᵢ})iₑₓₚₜ.

These equations are exactly the same of Boltzmann machine-learning, as it is known in computer science. So, the couplings g can be found by training a neural network, where the learning rate is given by:

$$Δ {g}_{μ} ( t + 1 ) = - η ( t ) hhO {\hat{}}_{μ} {i}_{g ( t )} - hO {\hat{}}_{μ} {i}_{expt} i + α Δ {g}_{μ} ( t ) ,$$

In terms of optimizing the process, the following thought may also be considered:

The reduction of the given problem to the inverse Ising Problem allows us to use some approximation method in alternative to the use of the trained algorithm. The first order (naive) approximation within the mean field theory (nMF) gives:

$${J}^{n M F} = {A}^{- 1} {C}^{- 1} .$$

$${H}_{i}^{n M F} - {tanh}^{- 1} 〈 si 〉 {Σ}_{j = 1}^{N} {J}_{ij}^{nMF} 〈 s i 〉 .$$

Where Aᵢⱼ=(1− [symbol] sᵢ [symbol] ²) δᵢⱼ and δᵢⱼ is the Kronecker delta. The second order correction to the nMF approximation requires solving Thouless-Anderson-Palmer (TAP) equations:

$${( {C}^{- 1} )}_{ij} = - {J}_{ij}^{TAP} - 2 {( {J}_{ij}^{TAP} )}^{2} 〈 {s}_{i} 〉 〈 {s}_{j} 〉 ,$$

$${h}_{i}^{TAP} = {h}_{i}^{nMF} - 〈 {s}_{i} 〉 {\sum }_{j = 1}^{N} {( {J}_{ij}^{TAP} )}^{2} ( 1 - {〈 {s}_{i} 〉}^{2} ) ,$$

The simplest independent-pair (IP) approximation assumes independence of every stock pair from the rest of the system. In this case, couplings and external fields can be found as:

$${J}_{ij}^{pair} = 1 / 4 ln [ \frac{( 1 + {m}_{i} + {m}_{j} + {C}_{ij}^{*} ) ( 1 - {m}_{i} - {m}_{j} + {C}_{ij}^{*} )}{( 1 - {m}_{i} - {m}_{j} - {C}_{ij}^{*} ) ( 1 + {m}_{i} - {m}_{j} - {C}_{ij}^{*} )} ] ,$$

$${h}_{i}^{pair} = 1 / 2 ln ( \frac{( 1 + {m}_{i}}{( 1 - {m}_{i}} ) - {\sum }_{i}^{N} {J}_{ij}^{pair} ) {m}_{j} + O ( {β}^{2} )$$

$${C}_{ij}^{*} = {C}_{ij} - {m}_{i} {m}_{j} .$$

As known, Sessak and Monasson (SM) derived higher-order corrections to the IP approximation using other terms in the perturbative correlation expansion:

$${J}_{ij}^{SM} = {J}_{ij}^{nMF} + {J}_{ij}^{pair} - \frac{{C}_{ij}}{( 1 - {m}_{ij}^{2} ) ( 1 + {m}_{ij}^{2} ) - {( {C}_{ij} )}^{2}} ,$$

$${h}_{i}^{SM} = {h}_{i}^{pair} .$$

It is also worth noting that some other approximate inference schemes tailored to different system regimes have been developed, such as a pseudo-maximum likelihood inference using all the data.

In order to produce the final graph, one can use the well-known technique of the minimal spanning tree (MST) to reduce the number of edges computed by the machine learning model or the approximation method.

The MST technique applied to the inferred couplings could show the presence of delays effected by one specific job to others, even some which one cannot see.

In the following, a detailed description of the figures will be given. All instructions in the figures are schematic. Firstly, a block diagram of an embodiment of the inventive computer-implemented method for controlling a plurality of IT processes is given. Afterwards, further embodiments, as well as embodiments of the control system for controlling a plurality of IT processes will be described.

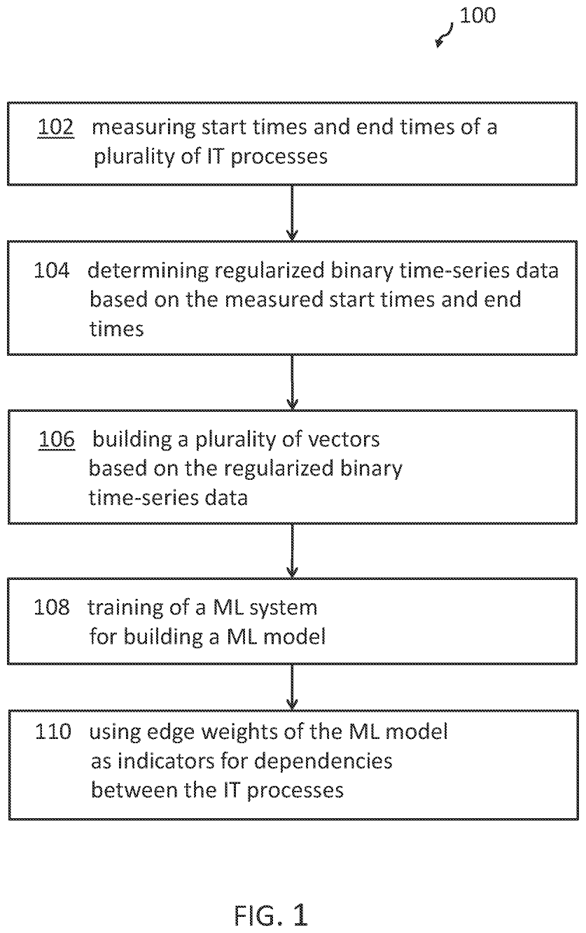

FIG. 1 shows a block diagram of a preferred embodiment of the computer-implemented method 100 for controlling a plurality of IT processes. Such controlling for IT processes, i.e., IT jobs on computer systems can be very useful in projects such as data migration or integration, business process execution, server migration and administration, where it is a strong requirement and prerequisite to know the architecture-based required sequence of IT processes.

The method 100 comprise measuring, 102, periodically start-times and related end-times of each of the plurality of IT processes during a first time interval. From these data, individual run or execution times for the IT processes can be derived by building the difference between the end-times and start-times.

Then, the method 100 comprises determining, 104, for each of the IT processes, regularized binary time-series data—in particular, regularized in the time domain—based on the measured start-times and the related end-times, during a second time interval. Thereby, the second time interval shall be directly subsequent to the first time interval.

Next, the method 100 comprises building, 106, a plurality of vectors, wherein each component of each of the vectors of the plurality represents data of a respective one of the time-series data of the plurality of IT processes during a given second time interval such that each component represents one IT process. Thereby, the components of the vectors are either ‘binary 0’—i.e., no delay—or ‘binary 1’—i.e., there is a delay.

The method 100 comprises also training, 108, of a machine-learning system to build a machine-learning model using the plurality of vectors as training data, thereby determining weights for edges—i.e., edge weights—between nodes of the machine-learning system, using the determined weights of the edges between the nodes as indicators for dependencies between the IT processes. Here, the machine-learning model is a fully connected neural network implementing a Boltzmann machine with 2 layers representing the inverted Ising model.

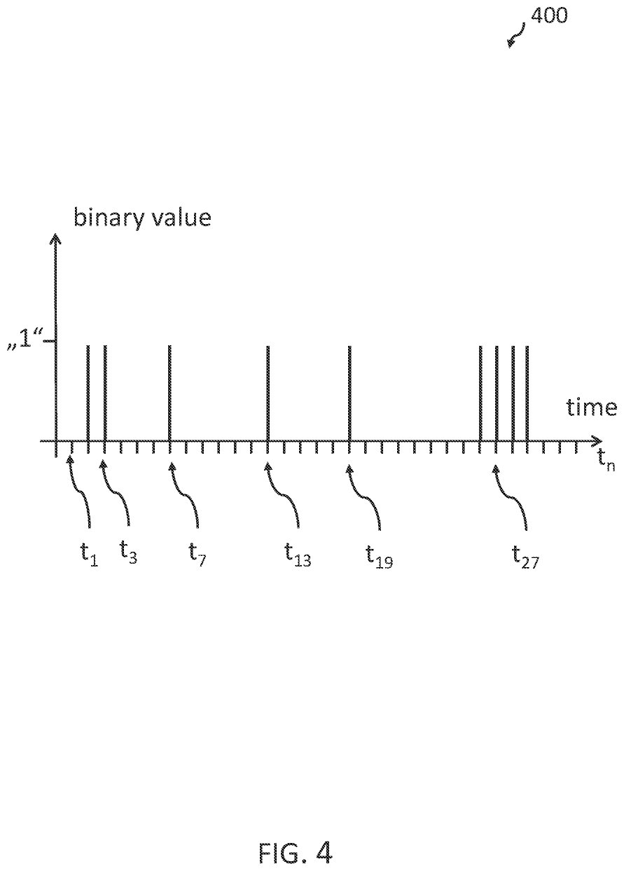

The training can be seen as supervised learning and the ground truth data for the training are represented real observations, i.e., based on measured start-times and end-times of a subsequent time period of measurement; so, to speak a next vector, as described in the context of FIG. 4.

Last but not least, the method 100 comprises using, 110, the determined weights of the edges between the nodes as indicators for dependencies between the IT processes.

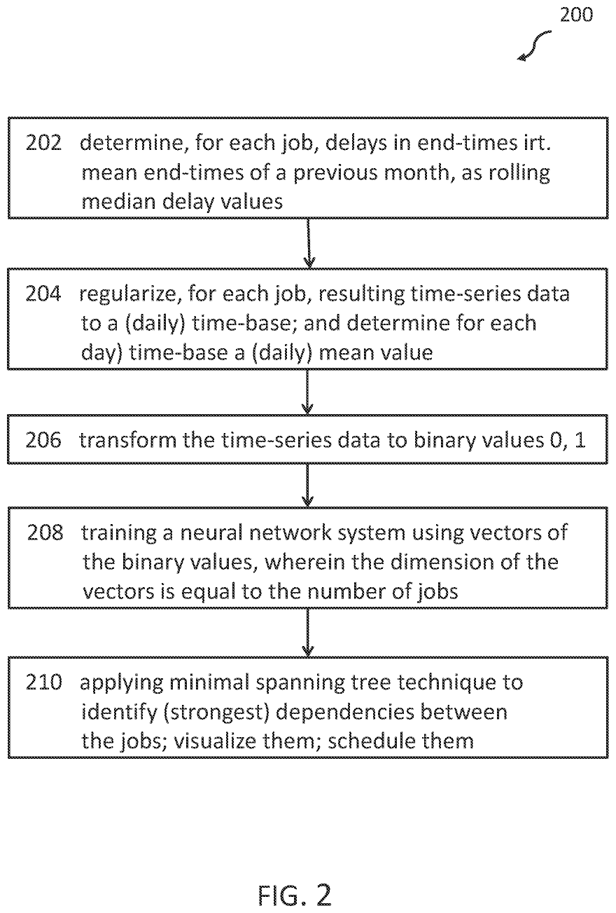

FIG. 2 shows a block diagram of an embodiment 200 of the inventive computer-implemented method for a specific application which delivers a different perspective to the same general inventive concept. Here, for each IT job, it is firstly determined, 202, which delays in the end-times in respect to the mean end-times of a previous time period exist, e.g., from a previous months for which a rolling mean delay values exist. These are regularized, 204, for each job (i.e., IT job) resulting in time-series data to a predefined time base (e.g., daily). Furthermore, for each time period—in this case, per day—a mean value is determined.

Next, these time series data are then transformed, 206, or converted to binary values, i.e., “0” and “1”. This may happen in the following way: Each time, an IT job needs more time from start to finish, than the mean value, the binary time series data show a “1” for this related time. And every time an IT job needs less time from start to finish of the respective IT job than the respective mean value, the binary (regularized) time series data show a “0”.

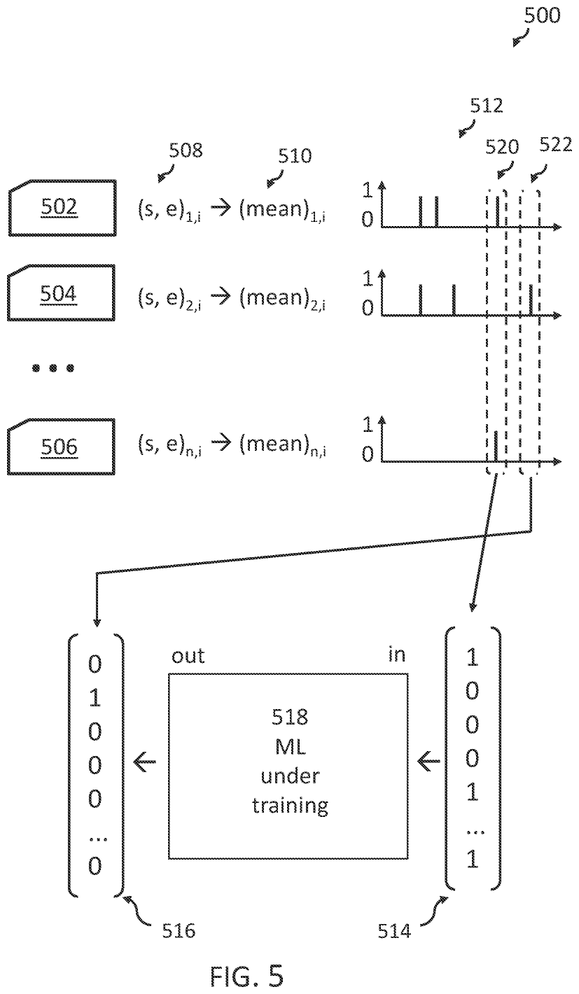

These regularized binary time series data are then used to train, 208, a neural network system. Thereby, the binary values of the binary regularized time series data are taking in a specific way, which will be explained in more detail in FIG. 5. In short, each dimension of the training vector corresponds to one of the IT jobs. Hence, the dimension of the training vectors is equal to the number of IT jobs under control.

Finally, a minimum spanning tree techniques is applied, 210, to identify the (strongest) dependencies between the IT jobs. These can then be visualized for control purposes. Furthermore, the IT jobs can also be managed in a way to make use of the knowledge of the inter-process (or inter-IT-job-dependencies) in order to determine a good sequence of scheduled start-times for individual IT jobs. Thereby, the overall load of the underlying hardware system can be averaged, i.e., peak or overload situations can be avoided in a new and inventive way.

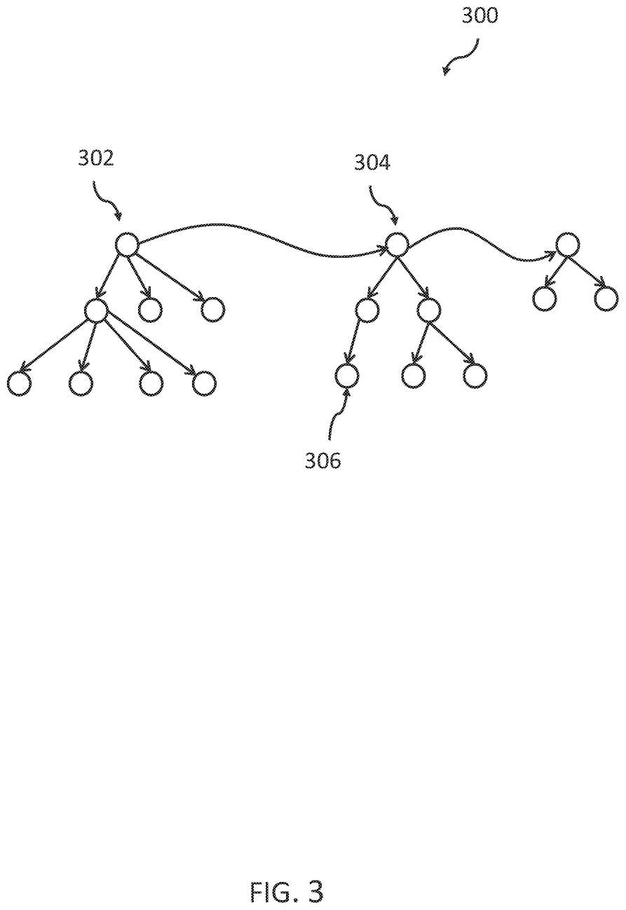

FIG. 3 shows a diagram of execution trees 300 of IT processes. Here, the circles may represent individual IT jobs of all IT processes. From the above-described measurements of start- and end-times a network graph is created which may also be visualized showing the dependencies between the IT processes. In the shown example, node 302 can be seen as root process because all other IT jobs depend on this IT job 302. Consequently, it is useless to start IT job 304 or 306 because they cannot be completely executed before IT job 304 has been finished.

FIG. 4 shows a diagram of an exemplary regularized binary time series graph 400. On the X-axis regular time intervals tₙ are shown. The “peaks” relating to the binary value “1” relate to those times that related IT job needed more time to execute (i.e., from start-time to end-time) than a before-determined mean execution time. Hence, here, the respective IT job did need more execution time than a mean value for this respective IT job at T={2, 3, 7, 13, 19, 26, 27, 28, 29}. For all other execution times, the respective IT job only required a period that is less than the average execution time of the respective IT job.

FIG. 5 shows an exemplary flow 500 of data from the measured IT process start-times and end-times 502, 504, . . . , 506 of the machine-learning system under training 518. From the start-times and end-times 502, 504, . . . , 506 of each process/IT job—here also denoted as (s, e)_{1,i} 508, i.e., start-time and end-time for IT job 1 during time period i—respective mean values (mean)_{1,i}, (mean)_{2,i}, . . . , (mean)_{1,n} 510 are determined. This is done during a setup of the system or a reference time period, e.g., for the last month. Then, during, e.g., an actual month, new execution times of IT processes/IT jobs are determined based on their start-times and respective end-times. These time series data are then transformed or converted to regularized binary time series data 512, as explained above.

In a next step, the training data vectors for the machine-learning (ML) system 518 under training are built. For this, all “0”s and “1”s for the same time period 520 are used to form an input training vector 514 for the machine-learning system 518. Thereby, the ground-truth vector 516 or label for the supervised learning of the underlying neural network (i.e., the machine-learning system under training 518) is the vector built from the “0”s and “1”s for the same time period 522. This way, the machine-learning system 518 is trained to predict the status of the networked system of IT jobs from the status that is one time period before.

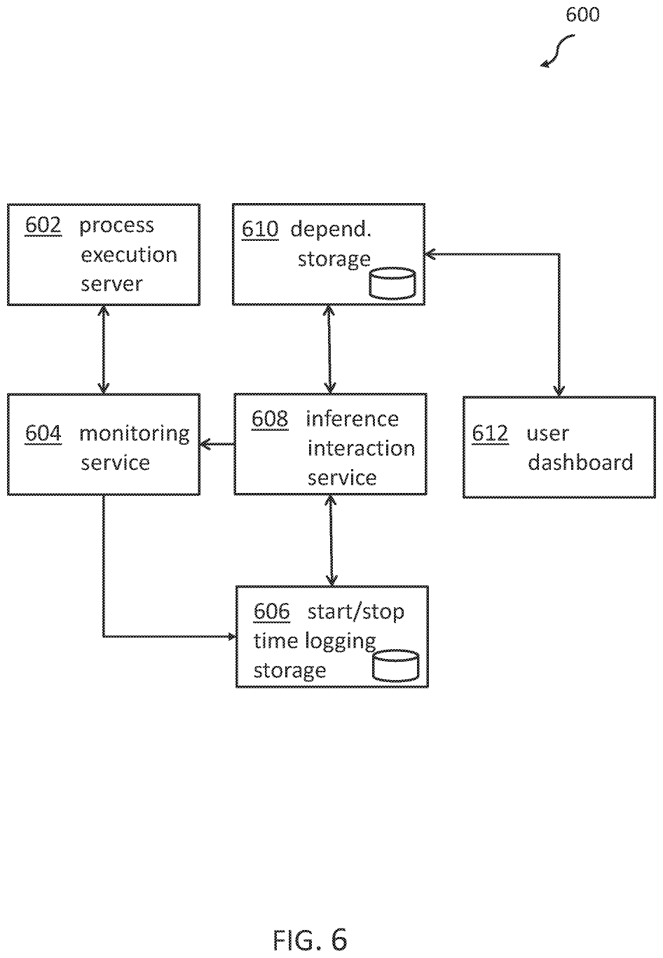

FIG. 6 shows a block diagram 600 of functional blocks for deploying the method for controlling a plurality of IT processes. On the process execution server 602, a plurality of IT jobs is executed. A monitoring service 604 has access to the start-times and stop or end-times of each of the IT jobs and stores these data on a start/stop time logging storage device 606.

The interference and action service 608—which is assumed to be trained already—accesses the start/stop time logging storage 606 and stores its results in the dependency storage 610. Via a user dashboard 612 users may now observe, monitor, and manage individual or groups of IT jobs to be executed on the process execution server 602.

In other words: The execution engine will be able to start and run all processes in the right order, recursively for each tree. Also, parallel processes are executed which dependent on the same IT process predecessor. The following pseudo code shall visualize this a little bit more comprehensively

```
Procedure Main
Begin
  For I := 1 to treeList.Count
    Execute (parent)
End;
Procedure Execute(JobNode: TJob)
Begin
  DoJob(JobNode);
  For I:= 1 to JobNode.ChildCount
    [async]
    Execute(Childs[I]);//dependent child jobs may execute in parallel
End.
```

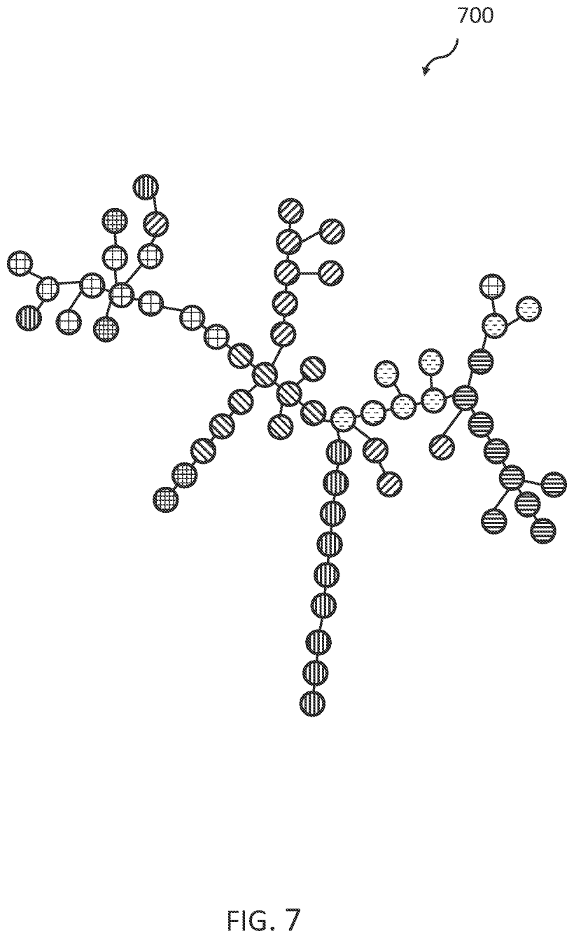

The user dashboard component 612 will also be able to show a network graph (compare FIG. 7) of the dependencies between IT jobs from the result of the inference job done by the inference interaction service or component 608: the interaction between two IT jobs is derived from the end-time of the IT jobs received via the monitoring service 604 from the process execution server 602.

To show satisfactory results, the dependency inference component or better inference interaction service 608 requires a significant amount of runs of the IT jobs (e.g., one month), so that the locks of all the executions must be stored in a storage point, namely the start and stop time storage data point 606, so that the interference process should be executed with at least monthly frequency. The result of the dependencies can be stored in a storage point 610, where the user dashboard 612 can retrieve the information.

In a nutshell, the inference interaction service 608 is thereby characterized by the following steps:
1. For each IT job the delays in end-time in respect of the median end-time of the previous month is determined, thereby a rolling median is determined;
2. For each IT job the resulting time series of the delay is regularized to a daily base, and for each day, the mean daily is determined (in real situation one will have one run per day);
3. The regularized time series is transformed into binary values by putting to “1” all the days with a delay greater than 1 hour;
4. A binary vector of the dimension of the jobs is built for each day and used to train a Boltzman Machine neural network. A Boltzman machine neural network can be reduced to represent an Ising model. From the trained model the inferred weights are used to represent the interaction;
5. As an alternative to activity 4 a mean field approximation method to infer the weights of the Ising model may be used as “shortcut”;
6. With the result of the activities 4 or 5 a minimal spanning tree technique is applied to identify the strongest dependences and show them.

FIG. 7 shows an exemplary diagram dependency diagram 700 of applying the technique of the minimal spanning tree (MST). Here, the same dependency groups are shown with the same striping or pattern of the circles, where each circle represents one IT job. In order to arrive at such a diagram, the known technique of the minimal spanning tree is used to reduce the number of edges—i.e., dependency lines between nodes/IT jobs—determined by the machine-learning model or a related approximate method. The resulting diagram of FIG. 7 for the MST is constructed using covariance and coupling matrices of binary time series built for other domains. A skilled person will be able to apply this approach to the task at hand using, e.g., articles published by R. Mantegna in Eur. Phys. J. B 11, 193 (1999), as well as by Borysov, S. S., Roudi, Y., & Balatsky, A. V. (2015) explaining US stock market interaction network as learned by the Boltzmann machine (published in The European Physical Journal B, 88(12), 1-14).

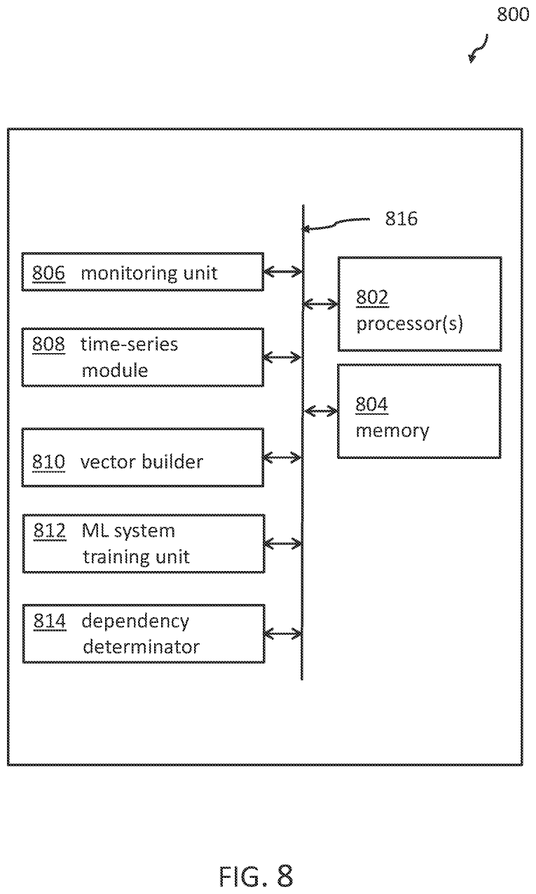

FIG. 8 shows a block diagram of an embodiment of the control system 800 for controlling a plurality of IT processes. Here, in contrast to FIG. 6, a different perspective may be used to describe the functional blocks of the control system 800. The system 800 comprises one or more processors 802 and a memory 804 operatively coupled to the one or more processors 802, wherein the memory 804 stores program code portions which, when executed by the one or more processors 802, enable the one or more processors 802 to measure—in particular by a monitoring unit 806—periodically start-times and related end-times of each of the plurality of IT processes, and determine, for each of the IT processes, regularized binary time-series data based on the measured start-times and the related end-times. For this, a time-series module 808 can be used. To illustrate the two different views of FIG. 6 and FIG. 8, it shall be comparatively easy to imagine similar functionalities of the monitoring unit 806 (of FIG. 8) and the monitoring service 604 (of FIG. 6). Other equivalents between the functional blocks of FIG. 6 and FIG. 8 may be built by a skilled person.

Then the one or more processors 802 are enabled to build a plurality of vectors—e.g., by a vector builder 810—wherein each component of each of the vectors of the plurality represents data of a respective one of the time-series data of the plurality of IT processes, and train of a machine-learning system to build a machine-learning model using the plurality of vectors as training data, thereby determining weights for edges between nodes of the machine-learning system. For this, a ML (machine-learning) system training unit 812 can be used.

Last but now least, the one or more processors 802 are enabled to use the determined weights of the edges between the nodes as indicators for dependencies between the IT processes. This can be performed by a dependency determinator 814.

It is shall also be mentioned that all functional units, modules, and functional blocks—in particular the one or more processors 802, the memory 804, monitoring unit 806, the time-series module 808, the vector builder 810, the ML system training unit 812 and the dependency determinator 814—may be communicatively coupled to each other for signal or message exchange in a selective 1:1 manner. Alternatively, the functional units, modules and functional blocks can be linked to a system internal bus system 816 for a selective signal and/or message exchange.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (CPP embodiment or CPP) is a term used in the present disclosure to describe any set of one, or more, storage media (also called mediums) collectively included in a set of one, or more, storage devices that collectively include machine readable code corresponding to instructions and/or data for performing computer operations specified in a given CPP claim. A storage device is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

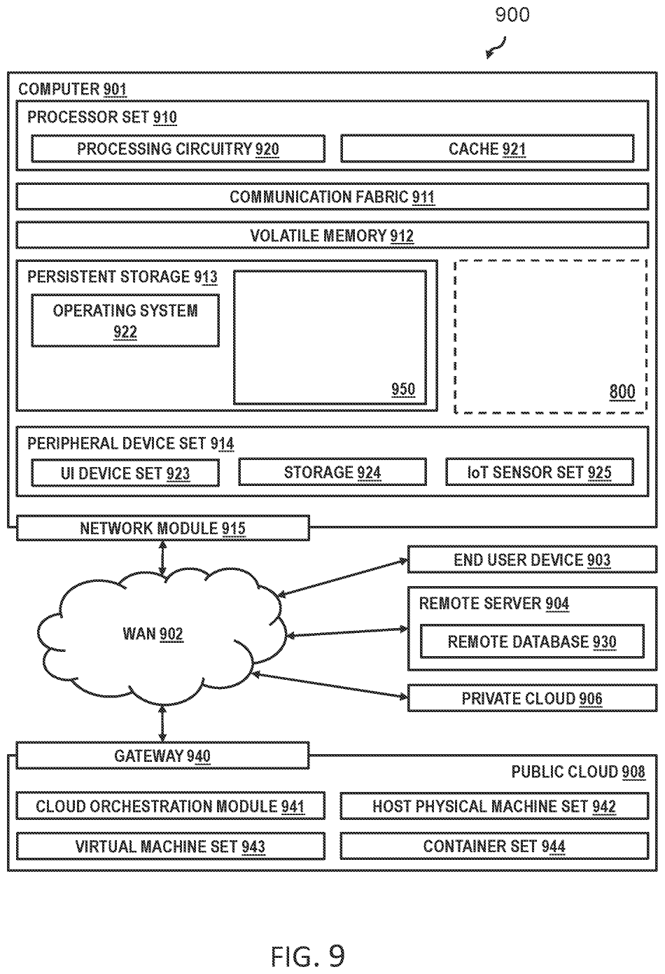

FIG. 9 shows a computing environment 900 comprising an example of an environment for the execution of at least some of the computer code involved in performing the inventive methods, such as a code block 950 for executing the computer-implemented method 100 for controlling a plurality of IT processes.

In addition to block 950, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 950, as identified above), peripheral device set 914 (including user interface (UI), device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located off chip. In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as the inventive methods). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 950 in persistent storage 913.

COMMUNICATION FABRIC 911 is the signal conduction paths that allow the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, the volatile memory is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface type operating systems that employ a kernel. The code included in block 950 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (e.g., embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where the computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as images. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

It should also be mentioned that the control system 800 for controlling a plurality of IT processes can be an operational sub-system of the computer 901 and may be attached to a computer-internal bus system.

The terminology used herein is for the purpose of describing particular embodiments only and is not intended to limit the invention. As used herein, the singular forms a, an and the are intended to include the plural forms as well, unless the context clearly indicates otherwise. It will further be understood that the terms comprises and/or comprising, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

In a nutshell, the inventive concept can be summarized the following clauses:

1. A computer-implemented method for controlling a plurality of IT processes, the method comprising
measuring periodically start-times and related end-times of each of the plurality of IT processes during a first time interval,
determining, for each of the IT processes, regularized binary time-series data based on the measured start-times and the related end-times, during a second time interval,
building a plurality of vectors, wherein each component of each of the vectors of the plurality represents data of a respective one of the time-series data of the plurality of IT processes during a given second time interval,
training of a machine-learning system to build a machine-learning model using the plurality of vectors as training data, thereby determining weights for edges between nodes of the machine-learning system,
   and
using the determined weights of the edges between the nodes as indicators for dependencies between the IT processes.
   2. The method according to clause 1, also comprising
visualizing the dependencies between the IT processes using the determined weights of the edges.
   3. The method according to clause 1 or 2, wherein the measuring the start-times and the related end-times also comprises
determining representative execution times for each of the plurality of IT processes.
   4. The method according to clause 3,
wherein the regularized binary time-series data are regularized in respect to a predetermined time unit, and
wherein the determining for each IT processes regularized binary time-series data comprises
   using a binary time-series schema based of the representative execution times.
      5. The method according to any of the preceding clauses, also comprising
determining the start-times and the related end-times regularly in predefined time intervals.
   6. The method according to of the preceding clauses, wherein the representative execution times are expected execution times or average execution times for each of the plurality of IT processes during the first time interval.
   7. The method according to of the preceding clauses, wherein the ML system is a fully connected neural network with two layers of nodes.
   8. The method according to clause 7, wherein each node represents one of the plurality of IT processes.
   9. The method according to of the preceding clauses, also comprising
allocating the IT processes in respect to available IT resources, thereby minimizing an overall IT resource usage.
   10. The method according to of the preceding clauses, wherein the training of a machine-learning system comprise
using first vectors of the plurality of vectors as input for the machine-learning system, and using second vectors of the plurality of vectors as ground truth, wherein the second vectors are pairwise directly subsequent to respective first vectors.
   11. A control system for controlling a plurality of IT processes, the system comprising
one or more processors and a memory operatively coupled to said one or more processors, wherein said memory stores program code portions which, when executed by said one or more processors, enable said one or more processors to
measure periodically start-times and related end-times of each of the plurality of IT processes,
determine, for each of the IT processes, regularized binary time-series data based on the measured start-times and the related end-times,
build a plurality of vectors, wherein each component of each of the vectors of the plurality represents data of a respective one of the time-series data of the plurality of IT processes,
train a machine-learning system to build a machine-learning model using the plurality of vectors as training data, thereby determining weights for edges between nodes of the machine-learning system,
   and
use the determined weights of the edges between the nodes as indicators for dependencies between the IT processes.
   12. The system according to clause 11, wherein the one or more processors are also enabled to
visualize the dependencies between the IT processes using the determined weights of the edges-
   13. The system according to clause 11 or 12, wherein the one or more processors, during the measuring the start-times and the related end-times, are also enabled to
determine representative execution times for each of the plurality of IT processes.
   14. The system according to clause 13,
wherein the regularized binary time-series data are regularized in respect to a predetermined time unit, and
wherein the one or more processors, during the determining for each IT processes regularized binary time-series data, are also enabled to
   use a binary time-series schema based on the representative execution times.
      15. The system according to of the clauses 11 to 14, the one or more processors are also enabled to
determining the start-times and the related end-times regularly in predefined time intervals.
   16. The system according to of the clauses 11 to 15, wherein the representative execution times are expected execution times or average execution times for each of the plurality of IT processes during the first time interval.
   17. The system according to of the clauses 11 to 16, wherein the machine-learning system is a fully connected neural network with two layers of nodes.
   18. The system according to of the clauses 11 to 17, also comprising
allocating the IT processes in respect to available IT resources, thereby minimizing an overall IT resource usage.
   19. The system according to of the clauses 11 to 18, wherein the one or more processors, during the training of a machine-learning system, are also enabled to
use first vectors of the plurality of vectors as input for the machine-learning system, and
use second vectors of the plurality of vectors as ground truth, wherein the second vectors are pairwise directly subsequent to respective first vectors.
   20. A computer program product for controlling a plurality of IT processes, the computer program product comprising a computer readable storage medium having program instructions embodied therewith, the program instructions being executable by one or more computing systems or controllers to cause the one or more computing systems to
measure periodically start-times and related end-times of each of the plurality of IT processes,
determine, for each of the IT processes, regularized binary time-series data based on the measured start-times and the related end-times,
build a plurality of vectors, wherein each component of each of the vectors of the plurality represents data of a respective one of the time-series data of the plurality of IT processes,
train a machine-learning system to build a machine-learning model using the plurality of vectors as training data, thereby determining weights for edges between nodes of the machine-learning system, and
use the determined weights of the edges between the nodes as indicators for dependencies between the IT processes.

What is claimed is:

1. A computer-implemented method for controlling a plurality of IT processes comprising:
measuring periodically start-times and related end-times of each of said plurality of IT processes during a first time interval;
determining, for each of said IT processes, regularized binary time-series data based on said measured start-times and said related end-times, during a second time interval;
building a plurality of vectors, wherein each component of each of said vectors of said plurality of vectors represents data of a respective one of said time-series data of said plurality of IT processes during a given second time interval;
training a machine-learning system to build a machine-learning model using said plurality of vectors as training data to determine weights for edges between nodes of said machine-learning system; and
using said determined weights of said edges between said nodes as indicators for dependencies between said IT processes.

2. The method according to claim 1, further comprising:
visualizing said dependencies between said IT processes using said determined weights of said edges.

3. The method according to claim 1, wherein said measuring said start-times and said related end-times further comprises:
determining representative execution times for each of said plurality of IT processes.

4. The method according to claim 3, wherein said regularized binary time-series data are regularized in respect to a predetermined time unit, and wherein said determining for each IT processes regularized binary time-series data comprises:
using a binary time-series schema based of said representative execution times.

5. The method according to claim 1, further comprising:
determining said start-times and said related end-times regularly in predefined time intervals.

6. The method according to claim 1, wherein said representative execution times are expected execution times or average execution times for each of said plurality of IT processes during said first time interval.

7. The method according to claim 1, wherein said ML system is a fully connected neural network with two layers of nodes.

8. The method according to claim 7, wherein each node represents one of said plurality of IT processes.

9. The method according to claim 1, further comprising:
allocating said IT processes in respect to available IT resources, thereby minimizing an overall IT resource usage.

10. The method according to claim 1, wherein said training of a machine-learning system comprises:
using first vectors of said plurality of vectors as input for said machine-learning system; and
using second vectors of said plurality of vectors as ground truth, wherein said second vectors are pairwise directly subsequent to respective first vectors.

11. A control system for controlling a plurality of IT processes comprising
one or more processors and a memory operatively coupled to said one or more processors, wherein said memory stores program code portions which, when executed by said one or more processors, enable said one or more processors to:
measure periodically start-times and related end-times of each of said plurality of IT processes;
determine, for each of said IT processes, regularized binary time-series data based on said measured start-times and said related end-times;
build a plurality of vectors, wherein each component of each of said vectors of said plurality of vectors represents data of a respective one of said time-series data of said plurality of IT processes;
train a machine-learning system to build a machine-learning model using said plurality of vectors as training data to determine weights for edges between nodes of said machine-learning system; and
use said determined weights of said edges between said nodes as indicators for dependencies between said IT processes.

12. The system according to claim 11, wherein said one or more processors are also enabled to:
visualize said dependencies between said IT processes using said determined weights of said edges.

13. The system according to claim 11, wherein said one or more processors, during said measuring said start-times and said related end-times, are also enabled to:
determine representative execution times for each of said plurality of IT processes.

14. The system according to claim 13, wherein said regularized binary time-series data are regularized in respect to a predetermined time unit, and wherein said one or more processors, during said determining for each IT processes regularized binary time-series data, are also enabled to:
use a binary time-series schema based on said representative execution times.

15. The system according to claim 11, wherein said one or more processors are also enabled to:
determining said start-times and said related end-times regularly in predefined time intervals.

16. The system according to claim 11, wherein said representative execution times are expected execution times or average execution times for each of said plurality of IT processes during said first time interval.

17. The system according to claim 11, wherein said machine-learning system is a fully connected neural network with two layers of nodes.

18. The system according to claim 11, further comprising:
allocating said IT processes in respect to available IT resources, thereby minimizing an overall IT resource usage.

19. The system according to claim 11, wherein said one or more processors, during said training of a machine-learning system, are also enabled to:
use first vectors of said plurality of vectors as input for said machine-learning system, and
use second vectors of said plurality of vectors as ground truth, wherein said second vectors are pairwise directly subsequent to respective first vectors.

20. A computer program product for controlling a plurality of IT processes, said computer program product comprising a computer readable storage medium having program instructions embodied therewith, said program instructions being executable by one or more computing systems or controllers to cause said one or more computing systems to:
measure periodically start-times and related end-times of each of said plurality of IT processes;
determine, for each of said IT processes, regularized binary time-series data based on said measured start-times and said related end-times;
build a plurality of vectors, wherein each component of each of said vectors of said plurality represents data of a respective one of said time-series data of said plurality of IT processes;
train a machine-learning system to build a machine-learning model using said plurality of vectors as training data to determine weights for edges between nodes of said machine-learning system, and
use said determined weights of said edges between said nodes as indicators for dependencies between said IT processes.
